(19) United States
(12) Patent Application Publication
(10) Pub. No.: US 2013/0100390 A1
(43) Pub. Date: Apr. 25, 2013

(54) Liquid Crystal Substrate and Manufacturing Method thereof, and Liquid Crystal Display Device

(71) Applicant: Yewen Wang, Guangdong (CN)

(72) Inventor: Yewen Wang, Guangdong (CN)

(21) Appl. No.: 13/375,546

(22) PCT Filed: Nov. 8, 2011
(86) PCT No.: PCT/CN2011/081916

§ 371 Date: Dec. 1, 2011

(30) Foreign Application Priority Data
Oct. 25, 2011 (CN) 201110327392.9

(51) Int. Cl. G02F 1/1343; B82Y 99/00

(52) U.S. Cl. 349/139; 349/187; 977/742; 977/952

(57) ABSTRACT

The invention discloses a liquid crystal substrate, a manufacturing method thereof, and an LCD device. A liquid crystal substrate comprises electrode(s), and the electrode is made of transparent conductive colloid. In the invention, because the transparent conductive colloid is used to replace ITO films to make the electrodes, and the transparent conductive colloid (such as nanometer silver colloid, carbon nanotube colloid and the like) forms a film after being applied and cured. Thus, the liquid crystal substrate has the advantages of low cost, simple process, immediate etching after being applied and dried. The cost of equipment required by PVD during ITO preparation is reduced, the FAB space is effectively used, the use amount of metal such as indium, tin and the like is reduced, the cost of equipment for manufacturing LCDs and liquid waste disposal is reduced, the manufacturing time is reduced, and the output is increased.

### TECHNICAL FIELD

The invention relates to the field of liquid crystal displays (LCDs), and more particularly to a liquid crystal substrate, a manufacturing method thereof, and an LCD display device.

### BACKGROUND

In the traditional LCD manufacturing process, transparent electrodes used for manufacturing thin film transistors (TFTs) and color filters (CFs) are made of indium tin oxide (ITO). In recent years, because the price of indium is increased, the cost of LCDs is increased. Further more, transparent electrodes are made of ITO using physical vapor deposition (PVD). Thus, the cost of LCDs is further increased because of complicated manufacturing process and expensive PVD equipment. In the increasingly mature LCD panel manufacturing process, cost and productivity become the crucial factors for promoting competitiveness, and obviously, cost rise is adverse to selling products. In addition, a great deal of waste liquid is generated in the PVD manufacturing process so that the environment is easily polluted. More particularly, indium has certain toxicity and threatens to the workmen's health if indium is used for a long time, and harm becomes even more serious if the waste liquid is not properly disposed.

### SUMMARY

One objective of the invention is to provide a liquid crystal substrate, a manufacturing method thereof with the advantages of low cost and environmental protection, and an LCD device.

The objective of the invention is achieved by the following technical schemes.

A liquid crystal substrate comprises electrode(s), wherein the electrode is made of transparent conductive colloid.

Preferably, the transparent conductive colloid is a nanometer silver colloid. This is one specific transparent conductive colloid material.

Preferably, the transparent conductive colloid is a carbon nanotube colloid. This is another specific transparent conductive colloid material.

Preferably, the liquid crystal substrate comprises an array substrate; the array substrate comprises TFTs, and the electrode is a TFT pixel electrode. This is a specific electrode form.

Preferably, the liquid crystal substrate comprises a color filter (CF) substrate, and the electrode is a common electrode of the CF substrate. This is another specific electrode form.

A manufacturing method of a liquid crystal substrate comprises the following steps:

A: Applying a transparent conductive colloid onto the position of an electrode, and then drying the applied transparent conductive colloid; and

B: Etching electrode shape using laser.

Preferably, the liquid crystal substrate is an array substrate, the step A is the last manufacturing process of the array substrate, and the transparent conductive colloid is a nanometer silver colloid. This is a specific manufacturing method of a pixel electrode of the array substrate.

Preferably, the liquid crystal substrate is a CF substrate. The step A comprises: sequentially preparing a black matrix (BM) and RGB color layer on the CF substrate, and then applying a carbon nanotube transparent conductive colloid onto the corresponding position of a common electrode. This is a specific manufacturing method of a common electrode of the CF substrate.

Preferably, the liquid crystal substrate is an array substrate. In the fringe field-switching (FFS) mode, the step A is the first and the last manufacturing process of the array substrate, and the transparent conductive colloid is a carbon nanotube transparent colloid. This is a specific manufacturing method of a pixel electrode of the array substrate in the FFS mode.

An LCD device comprises the aforementioned liquid crystal substrate.

By research, the inventor finds that the transparent conductive colloid has certain advantages in the aspects of penetration rate and electrical conductivity and is etched without using PVD. Thus, the transparent conductive colloid can be fully used in the field of LCDs. In the invention, because transparent conductive colloid is used to replace ITO films to make electrodes, the transparent conductive colloid (such as nanometer silver colloid, carbon nanotube colloid and the like) forms a film after being applied and cured, and has the advantages of low cost, simple process, immediate etching after being applied and dried. The cost of equipment required by PVD during ITO preparation is reduced , the fabrication plant (FAB) space is effectively used, the use amount of metal such as indium, tin and the like is reduced, the cost of equipment for manufacturing LCDs and liquid waste disposal is reduced, the manufacturing time is reduced, and the output is increased.

### BRIEF DESCRIPTION OF FIGURES

FIG. 1 is a structure diagram of example 1 of the invention;

Wherein: 132. gate electrode; 138. non-crystal silicon layer of active layer; 140a/b. crystal silicon layer of active layer; 134. source electrode; 136. drain electrode; 148. pixel electrode.

### DETAILED DESCRIPTION

The invention will further be described in detail in accordance with the figures and the preferred examples.

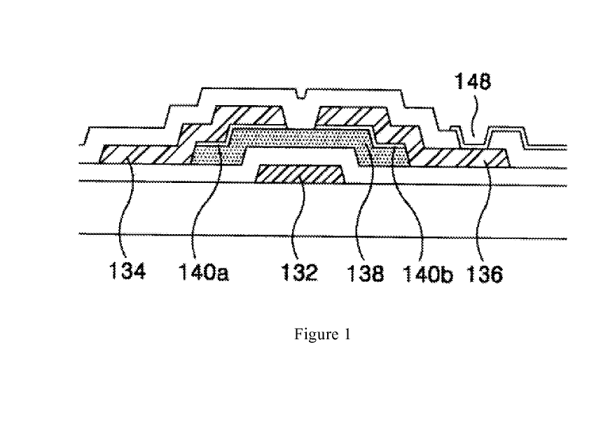

As shown in FIG. 1, an LCD device comprises a liquid crystal substrate; the liquid crystal substrate comprises electrode(s), and the electrode is made of a transparent conductive colloid. Transparent colloids such as nanometer silver colloid, carbon nanotube colloid, etc. which has good electrical conductivity can be used as the transparent conductive colloid. The liquid crystal substrate comprises an array substrate and a CF substrate. The array substrate comprises TFTs, and each TFT comprises a pixel electrode. The CF substrate is provided with common electrode(s), and all the electrodes can be made of the transparent conductive colloid.

The PVD equipment is expensive. The equipment cost is reduced by using the transparent conductive colloid as he electrode material, the FAB space is effectively used, the use amount of metal such as indium, tin and the like is reduced, and the cost of equipment for manufacturing LCDs and liquid waste disposal is reduced.

A manufacturing method of a liquid crystal substrate comprises the following steps:

A: Applying a transparent conductive colloid onto the position of an electrode, and then drying the applied transparent conductive colloid; and

B: Etching electrode shape by using laser.

The manufacturing method will further be described in detail in accordance the specific examples.

### Example 1

The step A comprises: Applying a nanometer silver colloid in the last manufacturing process of the array substrate.

As shown in FIG. 1, the nanometer silver colloid is applied in the last manufacturing process of the array substrate, and the electrode shape is etched by using laser after natural air-drying or drying the applied nanometer silver colloid. Each TFT comprises a gate electrode 132; a non-crystal silicon layer 138 (a-Si) of active layer, a crystal silicon layer 140a/b(n+Si) of active layer, a source electrode 134, a drain electrode 136 positioned on the same layer as the source electrode 134, and a pixel electrode 148 connected with the drain electrode 136 are sequentially arranged above the gate electrode 132. The pixel electrode 148 is made of nanometer silver colloid which is used to replace ITO to make electrodes.

### Example 2

The step A comprises: Sequentially preparing BM and RGB color layer on the CF substrate, and then applying acarbon nanotube transparent conductive colloid.

Sequentially preparing BM, RGB color layer, RGBY color layer or RGBW color layer on the CF substrate, applying the carbon nanotube transparent conductive colloid, and etching slits by using laser after naturally air-drying or drying the applied transparent conductive colloid.

### Example 3

The step A comprises: Applying a carbon nanotube transparent colloid in the first manufacturing process and the last manufacturing process of the array substrate in the FFS mode.

Applying the carbon nanotube transparent colloid on the array substrate in the first process and the last process of manufacturing the array substrate in the FFS mode, and using the dried and etched carbon nanotube transparent colloid to replace ITO to make electrodes. The FFS mode refers that the transparent conductive material is used as a pixel electrode, and the drive electric field is a transverse electric field, which increases the component mode of the vertical electric field.

The invention is described in detail in accordance with the above contents with the specific preferred examples. However, this invention is not limited to the specific examples. In addition to the aforementioned nanometer silver colloid and carbon nanotube colloid, other transparent conductive colloid can be used as the transparent conductive colloid. For the ordinary technical personnel of the technical field of the invention, on the premise of keeping the conception of the invention, the technical personnel can also make simple deductions or replacements, and all of which should be considered to belong to the protection scope of the invention.

We claim:

1. A liquid crystal substrate, comprising electrode(s); the electrode is made of transparent conductive colloid.

2. The liquid crystal substrate of claim 1, wherein said transparent conductive colloid is a nanometer silver colloid.

3. The liquid crystal substrate of claim 1, wherein said transparent conductive colloid is a carbon nanotube colloid.

4. The liquid crystal substrate of claim 1, wherein said liquid crystal substrate comprises an array substrate; said array substrate comprises TFTs, and said electrode is a TFT pixel electrode.

5. The liquid crystal substrate of claim 1, wherein said liquid crystal substrate comprises a CF substrate, and said electrode is a common electrode of the CF substrate.

6. A manufacturing method of liquid crystal substrate comprises the following steps:
A: Applying a transparent conductive colloid onto the position of an electrode, and then drying the applied transparent conductive colloid; and
B: Etching electrode shape by using laser.

7. The liquid crystal substrate of claim 6, wherein said liquid crystal substrate is an array substrate, said step A is the last manufacturing process of the array substrate, and the transparent conductive colloid is a nanometer silver colloid.

8. The manufacturing method of liquid crystal substrate of claim 6, wherein said liquid crystal substrate is a CF substrate; said step A comprises: Sequentially preparing BM and RGB color layer on the CF substrate, and then applying a carbon nanotube transparent conductive colloid onto the corresponding position of an common electrode.

9. The manufacturing method of liquid crystal substrate of claim 6, wherein said liquid crystal substrate is an array substrate, in the FFS mode, said step A is the first manufacturing process and the last manufacturing process of the array substrate, and the transparent conductive colloid is a nanometer silver colloid.

10. An LCD device, comprising: a liquid crystal substrate of claim 1; said liquid crystal substrate comprises electrode(s); said electrode is made of transparent conductive colloid.

11. An LCD device of claim 10, wherein said transparent conductive colloid is a nanometer silver colloid.

12. An LCD device of claim 10, wherein said transparent conductive colloid is a carbon nanotube colloid.

13. An LCD device of claim 10, wherein said liquid crystal substrate comprises an array substrate, said array substrate comprises TFTs, and said electrode is a TFT pixel electrode.

14. An LCD device of claim 10, wherein said liquid crystal substrate comprises a CF substrate, and said electrode is a common electrode of the CF substrate.
